(19) United States
(12) Patent Application Publication
(10) Pub. No.: US 2014/0095027 A1
(43) Pub. Date: Apr. 3, 2014

(54) DRIVING ASSISTANCE APPARATUS AND DRIVING ASSISTANCE METHOD

(71) Applicant: Yuji OKUDA, Susono-shi (JP)

(72) Inventor: Yuji OKUDA, Susono-shi (JP)

(73) Assignee: TOYOTA JIDOSHA KABUSHIKI KAISHA, Toyota-shi (JP)

(21) Appl. No.: 14/039,738

(22) Filed: Sep. 27, 2013

(30) Foreign Application Priority Data
Oct. 2, 2012 (JP) 2012-220382

(51) Int. Cl. G06F 7/00

(52) U.S. Cl. CPC G06F 7/00
USPC 701/41; 701/70

(57) ABSTRACT

A driving assistance apparatus includes: an advancement direction travel control unit that performs travel control in an advancement direction by applying at least one of a driving force and a braking force to a vehicle; an execution determination unit that determines whether or not the travel control in the advancement direction is being executed by the advancement direction travel control unit; and a driving assistance unit that performs driving assistance on the basis of a travel condition in the advancement direction of the vehicle, wherein the driving assistance unit suppresses the driving assistance when the execution determination unit determines that the travel control in the advancement direction is being executed by the advancement direction travel control unit.

### INCORPORATION BY REFERENCE

The disclosure of Japanese Patent Application No. 2012-220382, filed on Oct. 2, 2012 including the specification, drawings and abstract, is incorporated herein by reference in its entirety.

### BACKGROUND OF THE INVENTION

1. Field of the Invention

The invention relates to a driving assistance apparatus and a driving assistance method.

2. Description of Related Art

An apparatus which, when it is determined that a host vehicle may deviate from a lane in which the vehicle is currently traveling or the like, generates steering torque to keep a travel position of the host vehicle within the lane has been described as a conventional apparatus for assisting driving of a host vehicle, for example in Japanese Patent Application Publication No. 2001-301640 (JP 2001-301640 A). Further, Published Japanese Translation of PCT Application No. 2008-542934 (JP-A-2008-542934) describes a control unit that detects inattention of a driver on the basis of variation in a steering wheel angle generated by a steering action of the driver, and issues a warning when inattention is detected.

As a result of the driving assistance performed by a lane keeping apparatus such as that described above, a steering angle and a lateral position of the host vehicle may vary rapidly, causing the host vehicle to waver. In certain cases, however, it may be difficult to determine whether the wavering is due to diminished awareness in the driver or the control performed by the lane keeping apparatus. Therefore, when the lane keeping apparatus and the control unit are used concurrently, for example, and the host vehicle wavers due to steering control performed by the lane keeping apparatus while the driver remains fully attentive, the wavering may be detected by the control unit as diminished awareness in the driver, and as a result, a warning may be issued, causing the driver to experience a sense of discomfort.

A similar sense of discomfort may arise in the driver during travel control performed in a vehicle advancement direction, such as auto cruise control (ACC), as well as the control performed by the lane keeping apparatus described above. For example, it is difficult to determine whether wavering in the advancement direction resulting from a sudden deceleration performed to adjust an interval with a preceding vehicle is due to diminished awareness in the driver or the travel control. Therefore, the wavering may be detected as diminished awareness even when the driver is fully attentive, and as a result, driving assistance such as warning issuance may be performed.

### SUMMARY OF THE INVENTION

The invention provides a driving assistance apparatus and a driving assistance method with which a sense of discomfort experienced by a driver when driving assistance is performed during vehicle travel control can be reduced.

A first aspect of the invention is a driving assistance apparatus including: an advancement direction travel control unit that performs travel control in an advancement direction by applying at least one of a driving force and a braking force to a vehicle; an execution determination unit that determines whether or not the travel control in the advancement direction is being executed by the advancement direction travel control unit; and a driving assistance unit that performs driving assistance on the basis of a travel condition in the advancement direction of the vehicle, wherein the driving assistance unit suppresses the driving assistance when the execution determination unit determines that the travel control in the advancement direction is being executed by the advancement direction travel control unit.

A second aspect of the invention is a driving assistance method including: performing travel control in an advancement direction by applying at least one of a driving force and a braking force to a vehicle; determining whether or not the travel control in the advancement direction is being executed; performing driving assistance on the basis of a travel condition in the advancement direction of the vehicle; and suppressing the driving assistance when the travel control in the advancement direction is determined to be underway.

With the driving assistance apparatus and driving assistance method according to the invention, the driving assistance is suppressed when advancement direction wavering occurs as a result of the travel control in the advancement direction, and therefore the sense of discomfort experienced by the driver can be reduced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing a driving assistance apparatus according to a first embodiment;

FIG. 2 is a flowchart showing an example of an operation of the driving assistance apparatus according to the first embodiment;

FIG. 3 is a flowchart showing an example of an operation of the driving assistance apparatus according to the first embodiment;

FIG. 4 is a flowchart showing an example of an operation of the driving assistance apparatus according to the first embodiment;

FIG. 5 is a flowchart showing an example of an operation of the driving assistance apparatus according to the first embodiment;

FIG. 6 is a block diagram showing a driving assistance apparatus according to a second embodiment; and

FIG. 7 is a flowchart showing an example of an operation of the driving assistance apparatus according to the second embodiment.

### DETAILED DESCRIPTION OF EMBODIMENTS

Embodiments of the invention will be described in detail below using the drawings. Note that identical reference symbols have been used for identical and corresponding elements, and duplicate description thereof has been omitted.

A driving assistance apparatus according to the invention includes: an advancement direction travel control unit that performs travel control in an advancement direction by applying at least one of a driving force and a braking force to a vehicle; an execution determination unit that determines whether or not the travel control in the advancement direction is being executed by the advancement direction travel control unit; and a driving assistance unit that performs driving assistance on the basis of a travel condition in the advancement direction of the vehicle, wherein the driving assistance unit suppresses the driving assistance when the execution determination unit determines that the travel control in the advancement direction is being executed by the advancement direction travel control unit. Here, the driving assistance includes detecting and determining diminished awareness in a driver, issuing a warning in relation to the diminished awareness of the driver, and so on, while suppressing the driving assistance includes suppressing the determination that the driver is in the state of diminished awareness, for example, prohibiting the detection of diminished awareness through a diminished awareness determination and increasing a detection threshold so that diminished awareness is less likely to be determined, and surprising the issue of the warning based on the diminished awareness determination, for example, reducing a level of the warning based on the diminished awareness determination, not issuing a warning even after diminished awareness is determined.

### First Embodiment

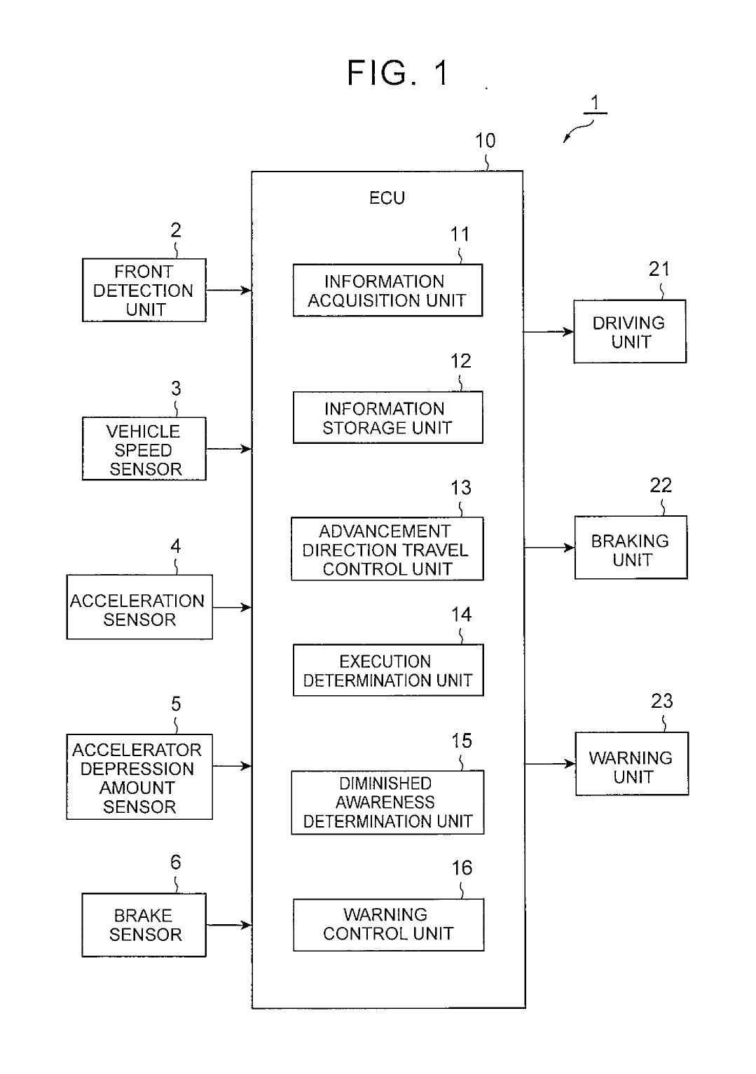

FIG. 1 is a block diagram showing an outline of a configuration of a driving assistance apparatus 1 according to a first embodiment of the invention. The driving assistance apparatus 1 has functions for executing travel control in an advancement direction, determining whether or not the awareness of a driver is diminished, and alerting the attention of the driver by issuing a warning when the awareness of the driver is diminished.

The driving assistance apparatus 1 includes a front detection unit 2, a vehicle speed sensor 3, an acceleration sensor 4, an acceleration depression amount sensor 5, a brake sensor 6, an electronic control unit (ECU) 10, a driving unit 21, a braking unit 22, and a warning unit 23.

The front detection unit 2 detects a condition ahead of a vehicle (also referred to hereafter as a “host vehicle”). A sensor attached to a front portion of the vehicle in order to emit laser light frontward and detect the presence of a preceding vehicle, an inter-vehicle distance between the vehicle and the preceding vehicle, and so on from resulting reflected light, for example, is used as the front detection unit 2. The front detection unit 2 may also be a camera that captures images of the front of the vehicle, for example, and in this case, a captured image or a captured video may be used to detect the presence of an obstruction. The front detection unit 2 is connected to the ECU 10 so that an output signal thereof is input into the ECU 10.

The vehicle speed sensor 3 detects a vehicle speed of the vehicle. A vehicle wheel speed sensor, for example, is used as the vehicle speed sensor 3. The vehicle speed sensor 3 is connected to the ECU 10 so that an output signal thereof is input into the ECU 10.

The acceleration sensor 4 detects an acceleration of the vehicle. An acceleration sensor provided in the front portion of the host vehicle in order to detect a front-rear acceleration and a lateral acceleration of the host vehicle, for example, is used as the acceleration sensor 4. The acceleration sensor 4 is connected to the ECU 10 so that an output signal thereof is input into the ECU 10.

The accelerator depression amount sensor 5 detects a depression amount (an opening) of an accelerator pedal. The acceleration depression amount sensor 5 is connected to the ECU 10 so that an output signal thereof is input into the ECU 10.

The brake sensor 6 functions as a brake pedal operation detection unit that detects an operating condition of a brake pedal generated by the driver, and is attached to a brake pedal in a vehicle cabin, for example. The brake sensor 6 is connected to the ECU 10 so that an ON signal output by the brake sensor 6 when the driver performs a brake operation by operating the brake pedal is input into the ECU 10.

The ECU 10 controls the entire driving assistance apparatus 1. For example, the ECU 10 has a computer including a central processing unit (CPU), a read only memory (ROM), and a random access memory (RAM) as a main body, and includes an input signal circuit, an output signal circuit, and a power supply circuit.

The ECU 10 includes at least an information acquisition unit 11, an information storage unit 12, an advancement direction travel control unit 13, an execution determination unit 14, a diminished awareness determination unit 15, and a warning control unit 16.

The information acquisition unit 11 repeatedly obtains various signals output from the front detection unit 2, the vehicle speed sensor 3, the acceleration sensor 4, the accelerator depression amount sensor 5, and the brake sensor 6, and stores the respective obtained signals in the information storage unit 12.

The advancement direction travel control unit 13 performs travel control (advancement direction travel control) in an advancement direction of the vehicle by applying at least one of a driving force and a braking force to the vehicle. The advancement direction travel control unit 13 outputs a driving force control signal to the driving unit 21, and outputs a braking force control signal to the braking unit 22. Here, the advancement direction travel control includes ACC, in which the vehicle is caused to travel while controlling the inter-vehicle distance to the preceding vehicle, and so on. Further, the advancement direction of the vehicle may include a rearward direction as well as a forward direction.

The execution determination unit 14 determines whether or not the advancement direction travel control is being executed by the advancement direction travel control unit 13. For example, the execution determination unit 14 determines whether or not the advancement direction travel control is being executed by the advancement direction travel control unit 13 by detecting the driving force control signal or the braking force control signal output to the driving unit 21 or the braking unit 22 from the advancement direction travel control unit 13.

The diminished awareness determination unit 15 determines whether or not the driver of the vehicle is in a state of diminished awareness. The diminished awareness determination unit 15 is included in a driving assistance unit that performs driving assistance, and may be a driver monitoring system or the like, for example. The driver of the vehicle is determined to be in the state of diminished awareness when specific vehicle behavior indicating diminished awareness is detected during travel in the advancement direction, for example when a gradual reduction in the vehicle speed is determined on the basis of the output signal output from the vehicle speed sensor 3, when gradual reduction in the accelerator pedal depression amount is determined on the basis of the output signal output from the accelerator depression amount sensor 5, when the inter-vehicle distance between the vehicle and the preceding vehicle is determined to be uneven on the basis of the output signal output from the front detection unit 2, and so on. When the specific vehicle behavior indicating diminished awareness is not detected, it is determined that the driver of the vehicle is not in the state of diminished awareness.

The warning control unit 16 controls an operation of the warning unit 23. The warning control unit 16 is included in the driving assistance unit that performs driving assistance, and outputs a warning control signal to the warning unit 23 when the driver is determined to be in the state of diminished awareness.

The information acquisition unit 11, information storage unit 12, advancement direction travel control unit 13, execution determination unit 14, diminished awareness determination unit 15, and warning control unit 16 described above are formed by installing software such as a program that executes functions and processing thereof in the ECU 10.

Note that the information acquisition unit 11, information storage unit 12, advancement direction travel control unit 13, execution determination unit 14, diminished awareness determination unit 15, and warning control unit 16 may be constituted by individual pieces of hardware, as long as the functions and processing thereof can be executed.

The driving unit 21 applies driving force to the vehicle. The driving unit 21 is operated in response to the driving force control signal output from the ECU 10. There are no particular limitations on the driving unit 21 as long as it is capable of applying driving force to the vehicle, and the driving unit 21 may be constituted by an engine ECU, a throttle motor, an injector, and so on, for example. The driving unit 21 executes vehicle travel driving corresponding to the driving force control signal.

The braking unit 22 applies braking force to the vehicle. The braking unit 22 is operated in response to the braking force control signal output from the ECU 10. There are no particular limitations on the braking unit 22 as long as it is capable of applying braking force to the vehicle, and the braking unit 22 may be constituted by a brake ECU, a solenoid valve that regulates a brake oil pressure, a pump motor that generates brake oil pressure, and so on, for example. The braking unit 22 executes vehicle braking corresponding to the braking force control signal.

The warning unit 23 issues warnings to the driver of the vehicle. The warning unit 23 is included in the driving assistance unit that performs driving assistance, and operated in response to the warning control signal output from the ECU 10. More specifically, the warning control signal is output from the warning control unit 16 to the warning unit 23 when the diminished awareness determination unit 15 determines that a reduction rate in the vehicle speed is determined to be at or above a predetermined vehicle speed reduction rate, that a reduction rate in the accelerator pedal depression amount is determined to be at or above a predetermined accelerator depression amount reduction rate, or that the variation rate in the inter-vehicle distance between the vehicle and the preceding vehicle is determined to be at or above the predetermined variation rate. The warning unit 23 then issues warnings to the driver of the vehicle in response to the warning control signal. A component that issues warnings to the driver via the hearing, sight, or touch of the driver is used as the warning unit 23. For example, a speaker, a buzzer, a monitor of a navigation system, a display, a lamp, an LED, a vibration device disposed on a steering wheel or a seat, and so on may be used as the warning unit 23.

Next, an operation of the driving assistance apparatus 1 according to the first embodiment will be described.

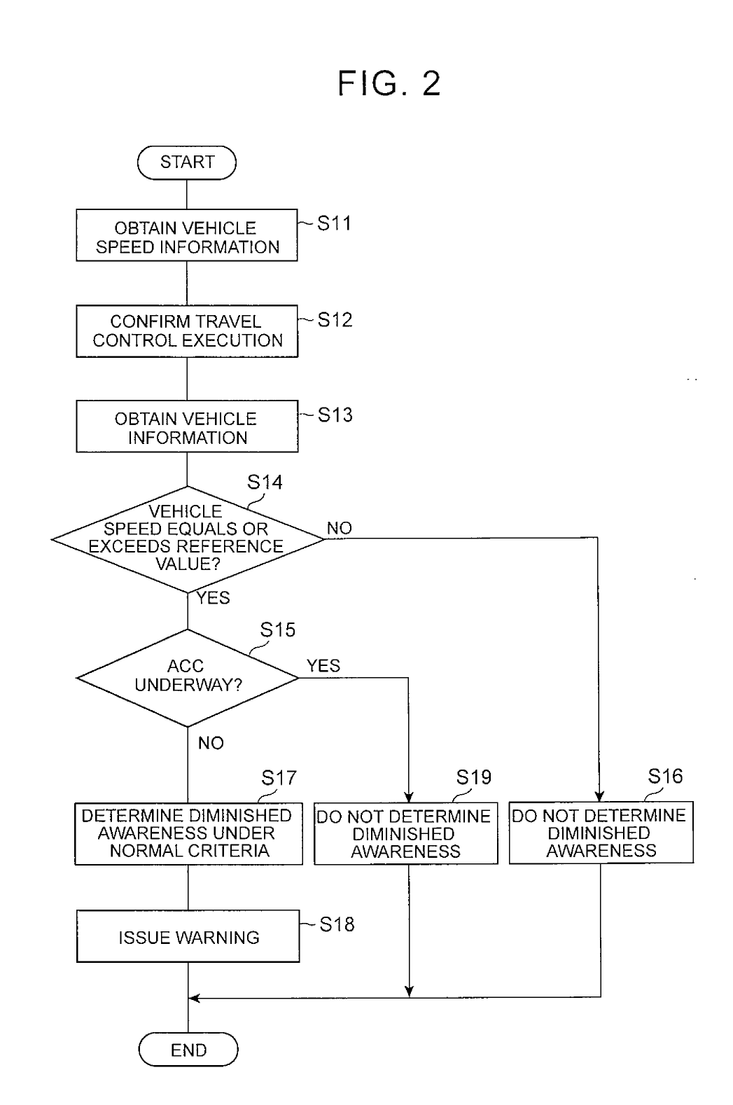

FIG. 2 is a flowchart showing an example of an operation of the driving assistance apparatus 1. A series of control processes shown on the flowchart is executed by the ECU 10 repeatedly at predetermined period intervals (100 ms, for example), for example. Further, the control processing shown on the flowchart is started when an ignition of the vehicle is switched ON, for example.

In the driving assistance apparatus 1, first, the information acquisition unit 11 obtains vehicle speed information indicating the vehicle speed of the host vehicle, which is output by the vehicle speed sensor 3 (S11). Further, when the driving force control signal or the braking force control signal is output by the advancement direction travel control unit 13, the execution determination unit 14 confirms that travel control (ACC and the like) is being executed by the advancement direction travel control unit 13 (S12). Next, the information acquisition unit 11 obtains the various signals output by the front detection unit 2, the acceleration sensor 4, the accelerator depression amount sensor 5, and the brake sensor 6 as vehicle information (S13).

Next, a determination is made as to whether or not the vehicle speed indicated by the vehicle speed information output from the vehicle speed sensor 3 equals or exceeds a reference value (S14). When it is determined that the vehicle speed equals or exceeds the reference value, the execution determination unit 14 determines whether or not ACC is being executed by the advancement direction travel control unit 13 (S15). When the vehicle speed is lower than the reference value, on the other hand, the current operation is terminated without having the execution determination unit 14 determine whether or not ACC is being executed by the advancement direction travel control unit 13 and without performing a diminished awareness determination (S16).

Further, when the execution determination unit 14 determines in S15 that ACC is being executed, the current operation is terminated without performing a diminished awareness determination based on a travel condition in the advancement direction of the vehicle (S19).

When the execution determination unit 14 determines in S15 that ACC is not being executed, on the other hand, the diminished awareness determination based on the travel condition in the advancement direction of the vehicle is performed under normal criteria (S17), and when the state of diminished awareness is determined, a warning is issued (S18).

Hence, according to the operation shown in FIG. 2, when it is determined that the ACC serving as the advancement direction travel control is underway, the diminished awareness determination based on the travel condition in the advancement direction of the vehicle is not performed, and therefore driving assistance is suppressed, with the result that the sense of discomfort experienced by the driver is reduced.

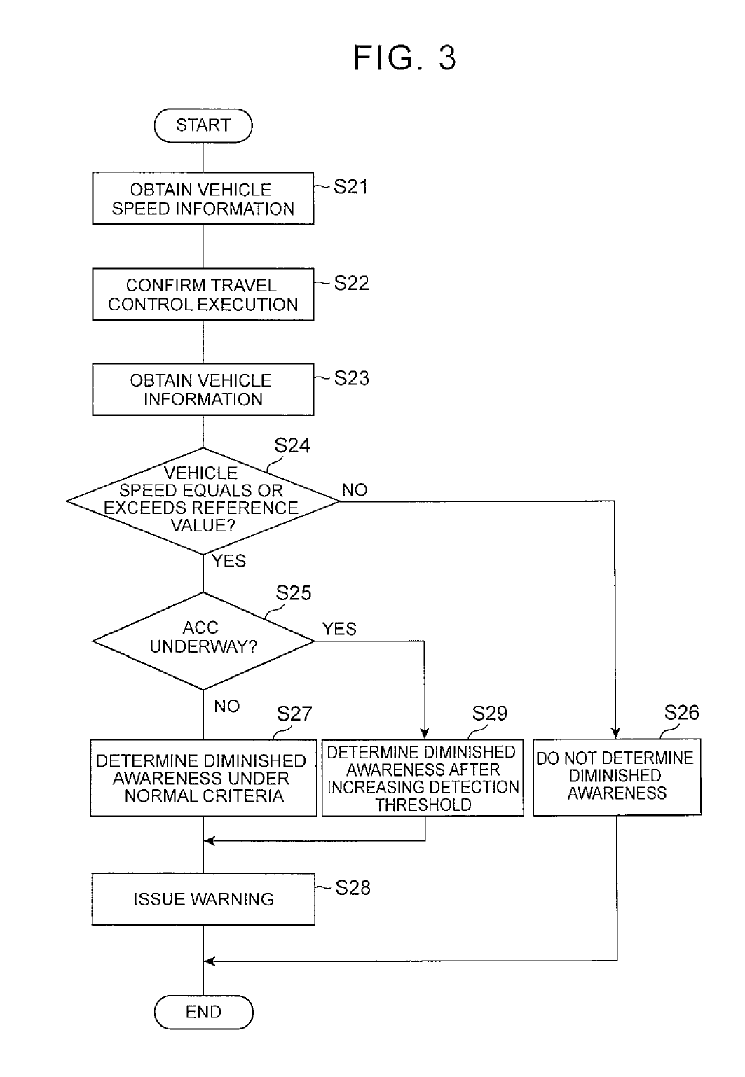

FIG. 3 is a flowchart showing an example of an operation of the driving assistance apparatus 1, serving as a modified example of the operation shown in FIG. 2. Operations of S21 to S28 in FIG. 3 are similar to the operations of S11 to S18 in FIG. 2, but differ as follows. When the execution determination unit 14 determines in S25 that the ACC serving as the advancement direction travel control is being executed by the advancement direction travel control unit 13, the diminished awareness determination based on the travel condition in the advancement direction of the vehicle is executed after increasing a detection threshold used in the diminished awareness determination (S29).

In a case where diminished awareness is determined due to a gradual reduction in the vehicle speed on the basis of the output signal output from the vehicle speed sensor 3, for example, the diminished awareness is determined when a vehicle speed reduction rate is determined to be at or above a threshold (predetermined vehicle speed reduction rate). In this case, increasing the detection threshold means setting the threshold of the vehicle speed reduction rate, used in the diminished awareness determination, at or above a predetermined value. In a case where diminished awareness is determined due to a gradual reduction in the accelerator pedal depression amount on the basis of the output signal output from the accelerator depression amount sensor 5, the diminished awareness is determined when an accelerator depression amount reduction rate is determined be at or above a threshold (predetermined accelerator depression amount reduction rate). In this case, increasing the detection threshold means setting the threshold of the accelerator depression amount reduction rate, used in the diminished awareness determination, at or above a predetermined value. Further, in a case where diminished awareness is determined due to unevenness in the inter-vehicle distance between the host vehicle and the preceding vehicle on the basis of the output signal output from the front detection sensor 2, the diminished awareness is determined when a variation rate in the inter-vehicle distance between the host vehicle and the preceding vehicle is determined to be at or above a threshold (predetermined variation rate). In this case, increasing the detection threshold means setting the threshold of the variation rate in the inter-vehicle distance between the host vehicle and the preceding vehicle, used in the diminished awareness determination, at or above a predetermined value. By setting the detection threshold higher in this manner, the state of diminished awareness is less likely to be determined.

Hence, according to the operation shown in FIG. 3, when it is determined that the ACC serving as the advancement direction travel control is underway, the detection threshold used in the diminished awareness determination based on the travel condition in the advancement direction of the vehicle is increased, making the state of diminished awareness less likely to be determined, whereby driving assistance such as warning issuance is also suppressed, and as a result, the sense of discomfort experienced by the driver can be reduced.

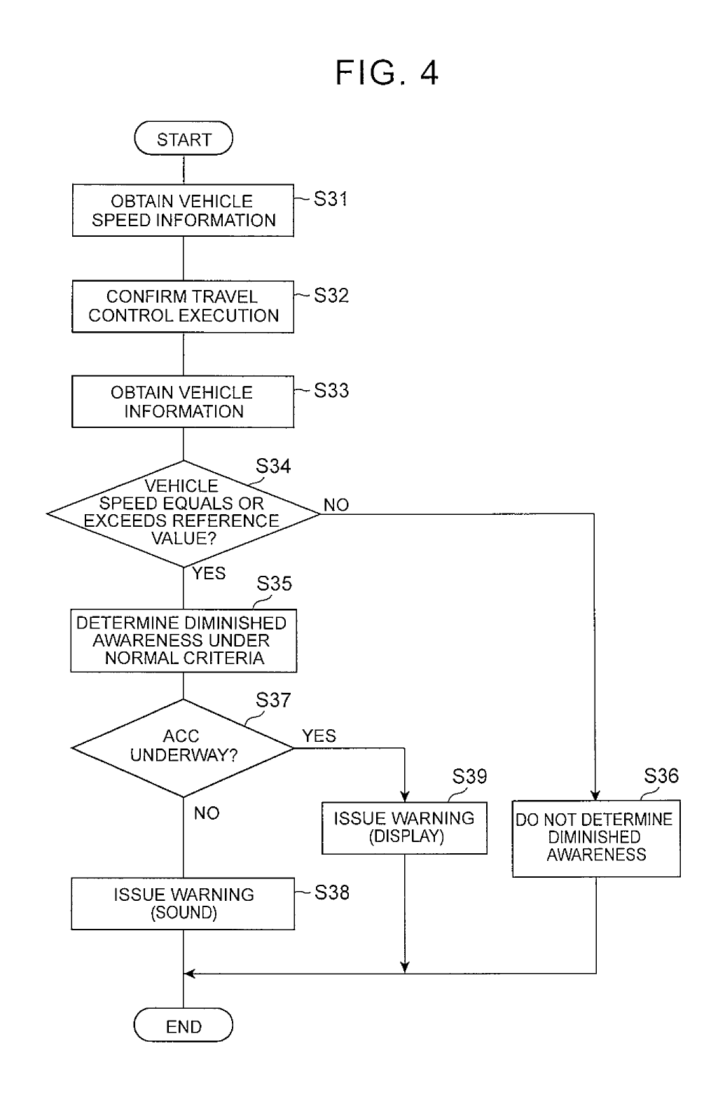

FIG. 4 is a flowchart showing an example of an operation of the driving assistance apparatus 1, serving as a modified example of the operations shown in FIGS. 2 and 3. Operations of S31 to S34 and S36 in FIG. 4 are similar to the operations of S11 to S14 and S16 in FIG. 2, but differ as follows. When it is determined in S34 that the value of the vehicle speed information output from the vehicle speed sensor 3 equals or exceeds the reference value, the diminished awareness determination based on the travel condition in the advancement direction of the vehicle is performed under normal criteria (S35). Next, the execution determination unit 14 determines whether or not ACC is underway (S37).

When the execution determination unit 14 determines in S37 that ACC is underway, a warning level used in the diminished awareness determination is reduced (for example, the warning is displayed on a monitor of the vehicle or the like), whereupon the warning is issued (S39). When it is determined in S37 that ACC is not underway, on the other hand, the warning is issued without reducing the warning level (for example, the warning is issued by sound or the like) (S38).

Hence, according to the operation shown in FIG. 4, when it is determined that the ACC serving as the advancement direction travel control is underway, driving assistance is suppressed by reducing the warning level (for example, by displaying the warning on screen rather than audibly) or the like, and as a result, the sense of discomfort experienced by the driver can be reduced.

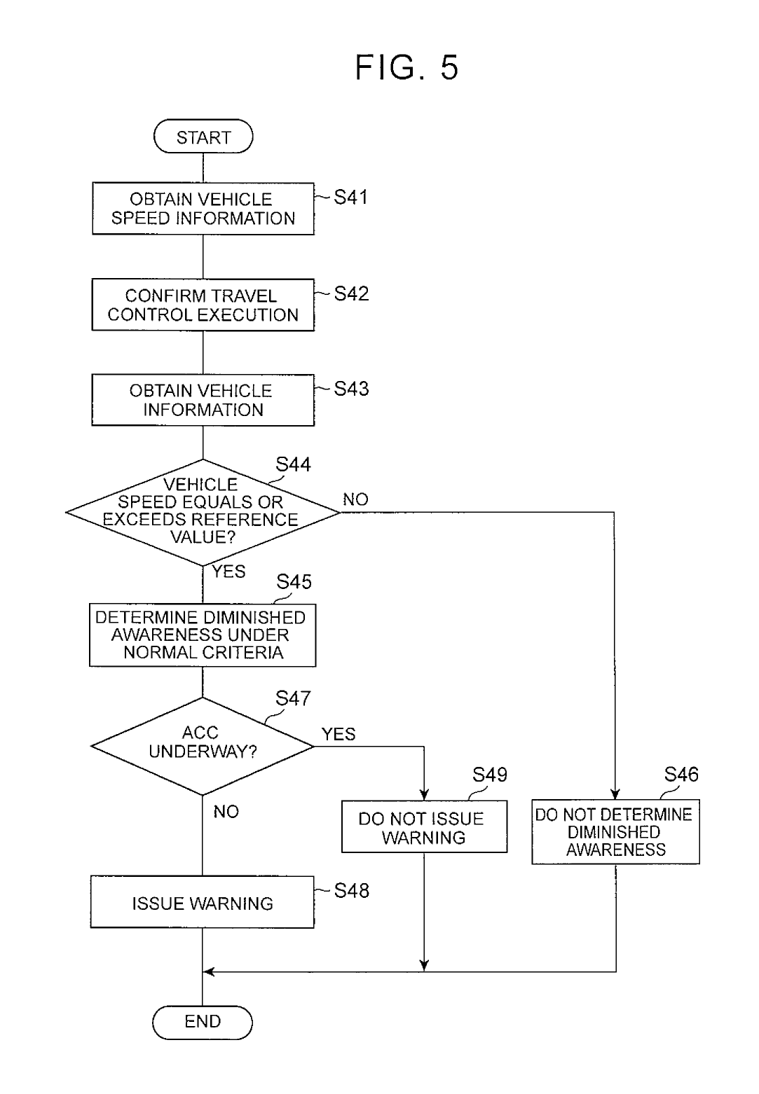

FIG. 5 is a flowchart showing an example of an operation of the driving assistance apparatus 1, serving as a modified example of the operation shown in FIG. 4. Operations of S41 to S48 in FIG. 5 are similar to the operations of S31 to S38 in FIG. 4, but differ as follows. When the execution determination unit 14 determines in S47 that ACC is underway, a warning is not issued in S49 even after the state of diminished awareness is determined on the basis of the travel condition in the advancement direction in S45 (S49).

Hence, according to the operation shown in FIG. 5, when it is determined that ACC is underway, driving assistance is suppressed by not issuing a warning after determining the state of diminished awareness or the like, and as a result, the sense of discomfort experienced by the driver can be reduced.

With the driving assistance apparatus 1 according to the first embodiment, as described above, the sense of discomfort experienced by the driver when driving assistance is performed during vehicle travel control can be reduced.

### Second Embodiment

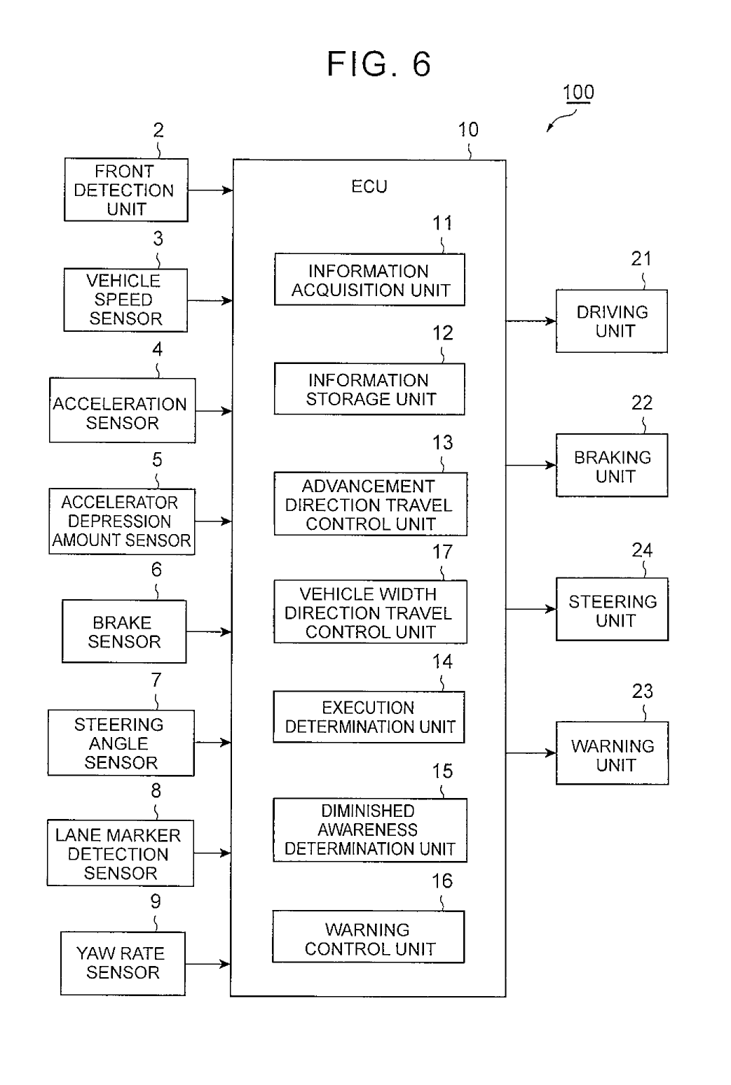

FIG. 6 is a block diagram showing an outline of a configuration of driving assistance apparatus 100 according to a second embodiment of the invention. The driving assistance apparatus 100 is an apparatus for assisting driving performed by a driver, having functions for executing travel control in the advancement direction, executing travel control in a vehicle width direction, and alerting the attention of the driver by issuing a warning when the awareness of the driver is diminished.

The driving assistance apparatus 100 includes, in addition to the configuration of the driving assistance apparatus 1 described above, a steering angle sensor 7, a lane marker detection sensor 8, a yaw rate sensor 9, a vehicle width direction travel control unit 17, and a steering unit 24.

The steering angle sensor 7 detects a steering angle of a steering wheel of the vehicle. A steering angle sensor that detects a rotation angle of a steering shaft, for example, is used as the steering angle sensor 7. The steering angle sensor 7 is connected to the ECU 10 so that an output signal thereof is input into the ECU 10. Note that a steering torque sensor may be used instead of the steering angle sensor 7. In this case, the steering angle of the steering wheel is calculated on the basis of a steering torque value output by the steering torque sensor. Further, any other component capable of obtaining the steering angle of the steering wheel may be used instead of the steering angle sensor 7.

The lane marker detection sensor 8 detects a lane marker on a traveled road. The lane marker detection sensor 8 captures images of the traveled road on the periphery of the traveling vehicle through a front window using a charge coupled device (CCD) camera, for example, and outputs captured moving image data to the ECU 10.

The yaw rate sensor 9 detects a yaw rate of the vehicle. The yaw rate sensor 9 is disposed near a center of gravity of the vehicle, for example, in order to detect the yaw rate about a vertical axis to the center of gravity. The yaw rate sensor 9 outputs yaw rate information relating to the detected yaw rate to the ECU 10.

The vehicle width direction travel control unit 17 performs travel control (vehicle width direction travel control) in the vehicle width direction by applying steering force to the vehicle. The vehicle width direction travel control unit 17 outputs a steering control signal to the steering unit 24. Here, lane keep assistance (LKA) in which the vehicle is controlled to travel in a travel lane, a warning is issued when the vehicle deviates from the lane, and so on, for example, may be cited as the vehicle width direction travel control.

The steering unit 24 steers the vehicle. The steering unit 24 is constituted by a steering ECU and an electric motor of an electric power steering system, for example. The steering unit 24 is activated upon reception of the steering control signal from the vehicle width direction travel control unit 17, and operates the steering wheel in accordance with the steering control signal.

The execution determination unit 14, in addition to the functions described above, determines whether or not travel control is being executed in the vehicle width direction by the vehicle width direction travel control unit 17. For example, the execution determination unit 14 determines whether or not travel control is being executed in the vehicle width direction by the vehicle width direction travel control unit 17 by detecting the steering control signal output from the vehicle width direction travel control unit 17 to the steering unit 24.

Further, the diminished awareness determination unit 15 determines that the driver of the vehicle is in the state of diminished awareness when specific vehicle behavior indicating diminished awareness is detected during travel in the vehicle width direction, for example when a non-steering condition is determined on the basis of the output signal output by the steering angle sensor 7, when the vehicle is determined to be advancing in a direction deviating from the travel lane on the basis of the output signal output by the lane marker detection signal 8, or the like.

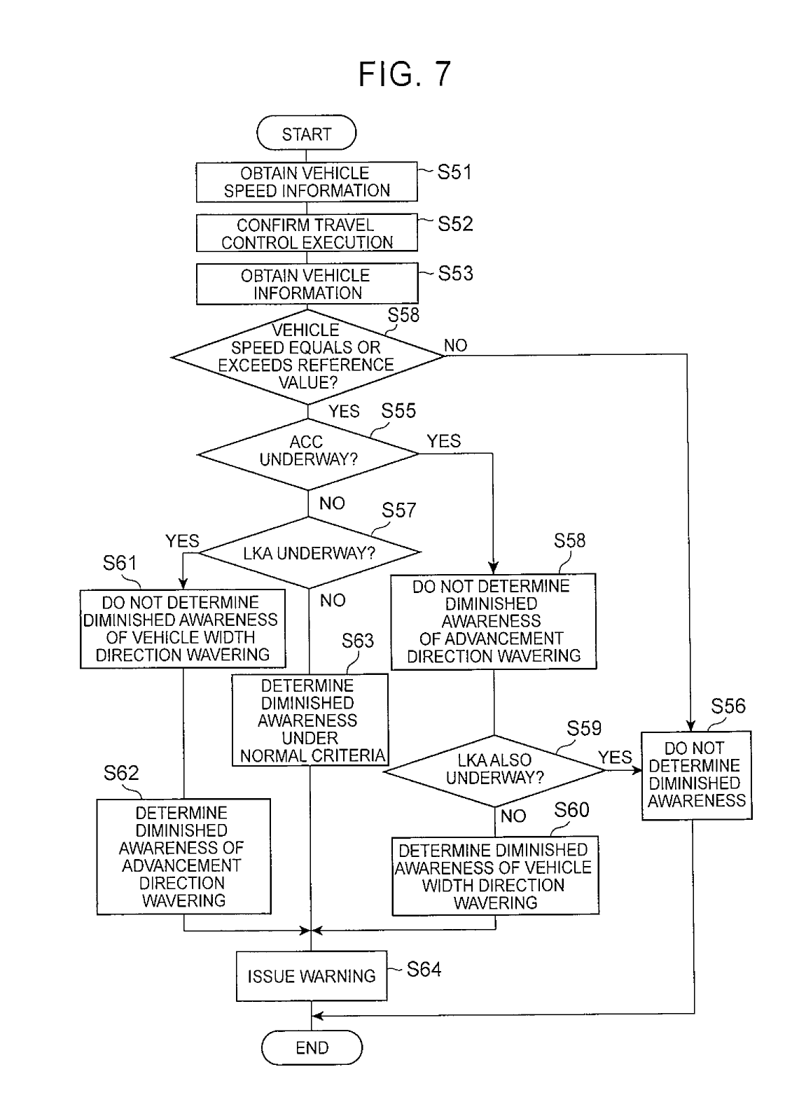

FIG. 7 is a flowchart showing an example of an operation of the driving assistance apparatus 100.

In the driving assistance apparatus 100, the information acquisition unit 11 obtains the vehicle speed information indicating the vehicle speed of the host vehicle, which is output by the vehicle speed sensor 3 (S51). Further, when the driving force control signal or the braking force control signal is output by the advancement direction travel control unit 13, the execution determination unit 14 confirms that travel control is being executed by the advancement direction travel control unit 13. Furthermore, when the steering control signal is output by the vehicle width direction travel control unit 17, the execution determination unit 14 confirms that travel control is being executed by the vehicle width direction travel control unit 17 (S52). Next, the information acquisition unit 11 obtains the various signals output by the front detection unit 2, the acceleration sensor 4, the accelerator depression amount sensor 5, the brake sensor 6, the steering angle sensor 7, the lane marker detection sensor 8, and the yaw rate sensor 9 as vehicle information (S53).

Next, a determination is made as to whether or not the vehicle speed indicated by the vehicle speed information output from the vehicle speed sensor 3 equals or exceeds the reference value (S54). When it is determined that the vehicle speed equals or exceeds the reference value, the execution determination unit 14 determines whether or not ACC, i.e. the travel control in the advancement direction, is being executed by the advancement direction travel control unit 13 (S55). When the vehicle speed is lower than the reference value (S54), on the other hand, the current operation is terminated without performing the diminished awareness determination (S56).

When the execution determination unit 14 determines in S55 that ACC is being executed, a diminished awareness determination relating to wavering in the advancement direction is not performed on the basis of the travel condition in the advancement direction (S58). In this case, the execution determination unit 14 determines whether or not LKA serving as the travel control in the vehicle width direction is being executed by the vehicle width direction travel control unit 17 (S59). When it is determined in S59 that LKA is being executed, the current operation is terminated without performing the diminished awareness determination (S56).

When it is determined in S59 that LKA is not being executed, on the other hand, a diminished awareness determination based on the travel condition in the vehicle width direction is performed (S60), and when the state of diminished awareness is determined, a warning is issued (S64).

Further, when it is determined in S55 that ACC is not being executed, the execution determination unit 14 determines whether or not LKA is being executed (S57). When it is determined in S57 that LKA is being executed, the diminished awareness determination relating to wavering in the advancement direction (S62) is performed without performing a diminished awareness determination relating to wavering in the vehicle width direction (S61), and when the state of diminished awareness is determined, a warning is issued (S64).

Further, when the execution determination unit 14 determines in S57 that LKA is not being executed, diminished awareness determinations are performed in relation to both wavering in the vehicle width direction and wavering in the advancement direction under normal criteria (S63), and when the state of diminished awareness is determined, a warning is issued (S64).

Hence, likewise in the driving assistance apparatus 100 according to the second embodiment, the sense of discomfort experienced by the driver when driving assistance is performed during vehicle travel control can be reduced.

Note that although the embodiments described above illustrate embodiments of the driving assistance apparatus according to the invention, the driving assistance apparatus according to the invention is not limited to the configurations described in the embodiments, and the driving assistance apparatus according to the invention may be applied to an altered or alternative driving assistance apparatus as long as the matter described in the claims is not modified.

For example, in the driving assistance apparatus 1 according to the first embodiment, driving assistance is suppressed by not performing the diminished awareness determination based on the travel condition in the advancement direction of the vehicle, increasing the detection threshold, and so on when advancement direction travel control (ACC, for example) is determined to be underway. However, when a required deceleration value of the ACC is large, for example, the deceleration value may approach a system limit, leading to an increase in danger, and therefore driving assistance may be suppressed only when the required deceleration value of the ACC is smaller than a predetermined value.

Further, in S19 of FIG. 2 and so on, the diminished awareness determination is not performed when ACC is underway or the like, but setting is preferably also performed to ensure that when ACC is switched OFF, the diminished awareness determination (the driver monitoring system, for example) is returned to its original condition (an ON condition in a case where the driver monitoring system or the like is ON prior to execution of the ACC) without the need for another driver operation.

Moreover, in the driving assistance apparatus 100 according to the second embodiment, the diminished awareness determination is performed in addition to the ACC executed as the travel control in the advancement direction and the LKA executed as the travel control in the vehicle width direction, and therefore the driver may become dependent on the driving assistance apparatus, leading to a reduction in the driving awareness of the driver. In such cases, therefore, the detection threshold of the diminished awareness determination may be set low (a determination threshold may be set on a side where warnings are more likely to be issued), albeit within a range that does not cause the driver to experience an increased sense of discomfort.

In the driving assistance apparatus 100 according to the second embodiment, a human machine interface (HMI) having a high warning effect may be employed to issue the warnings in response to the diminished awareness determination performed in relation to wavering in the vehicle width direction while ACC is underway and the diminished awareness determination performed in relation to wavering in the advancement direction while LKA is underway.

In S58 and S61 of FIG. 7, the diminished awareness determination relating to wavering in the advancement direction or wavering in the vehicle width direction is not performed, but the detection threshold may be increased so that the diminished awareness determination is performed.

Furthermore, in a case where the LKA includes a lane keeping support mode and a lane deviation warning mode, the lane deviation warning mode is activated only when the vehicle deviates from the lane, and therefore diminished awareness may be less likely to occur during driving than in the lane keeping support mode. Hence, to prevent an increase in the sense of discomfort experienced by the driver, it may be preferable to ensure that when LKA is executed in the lane deviation warning mode, warnings are not more likely to be issued in response to the diminished awareness determination based on the travel condition in the advancement direction while the LKA is underway.

Further, when the LKA is executed in the lane deviation warning mode, behavior such as wavering over a lane marker or rapid corrective steering following an increase in danger due to non-steering may be used as the subject of the diminished awareness determination in the vehicle width direction.

As described above, one aspect of the invention is a driving assistance apparatus including: an advancement direction travel control unit that performs travel control in an advancement direction by applying at least one of a driving force and a braking force to a vehicle; an execution determination unit that determines whether or not the travel control in the advancement direction is being executed by the advancement direction travel control unit; and a driving assistance unit that performs driving assistance on the basis of a travel condition in the advancement direction of the vehicle, wherein the driving assistance unit suppresses the driving assistance when the execution determination unit determines that the travel control in the advancement direction is being executed by the advancement direction travel control unit. Hence, the driving assistance is suppressed when advancement direction wavering occurs as a result of the travel control in the advancement direction, and therefore the sense of discomfort experienced by the driver can be reduced.

The driving assistance unit may include a diminished awareness determination unit that determines whether or not a driver of the vehicle is in a state of diminished awareness. In this case, the driving assistance unit may suppress a determination by the execution determination unit that the driver of the vehicle is in the state of diminished awareness when the diminished awareness determination unit determines that the travel control in the advancement direction is being executed by the advancement direction travel control unit. The driving assistance unit may also include a warning unit that issues a warning when the diminished awareness determination unit determines that the driver of the vehicle is in the state of diminished awareness. In this case, the driving assistance unit suppresses an issue of the warning by the warning unit when the execution determination unit determines that the travel control in the advancement direction is being executed by the advancement direction travel control unit. By suppressing driving assistance such as determining diminished awareness and issuing a warning, the sense of discomfort experienced by the driver can be further reduced.

The driving assistance apparatus may further include a vehicle width direction travel control unit that performs travel control in a vehicle width direction by applying a steering force to the vehicle. In this case, the execution determination unit may determine whether or not the travel control in the vehicle width direction is being executed by the vehicle width direction travel control unit, the diminished awareness determination unit may determine whether or not the driver of the vehicle is in the state of diminished awareness on the basis of a travel condition in the vehicle width direction of the vehicle, and the driving assistance unit may suppress the driving assistance when the vehicle width direction travel control unit is determined to be executing the travel control in the vehicle width direction. Hence, the driving assistance is suppressed not only when the vehicle wavers in the advancement direction but also when wavering occurs in the vehicle width direction, for example, as a result of the vehicle travel control in the vehicle width direction, and as a result, the sense of discomfort experienced by the driver can be even further reduced.

When the execution determination unit determines that the travel control in the advancement direction is being executed by the advancement direction travel control unit, the diminished awareness determination unit may determine diminished awareness on the basis of the travel condition in the vehicle width direction of the vehicle, and when the execution determination unit determines that the travel control in the vehicle width direction is being executed by the vehicle width direction travel control unit, the diminished awareness determination unit may determine diminished awareness on the basis of the travel condition in the advancement direction of the vehicle. By switching the subject of the diminished awareness determination in accordance with a travel control execution condition in this manner, a reduction in the awareness of the driver can be suppressed further while reducing the sense of discomfort experienced by the driver when the driving assistance is suppressed.

the driving assistance unit may issue a warning to a driver of the vehicle when a reduction rate in a vehicle speed is determined to be at or above a predetermined vehicle speed reduction rate, when a reduction rate in an accelerator pedal depression amount is determined to be at or above a predetermined accelerator depression amount reduction rate, or when a variation rate in a inter-vehicle distance between the vehicle and a preceding vehicle is determined to be at or above the predetermined variation rate.

What is claimed is:

1. A driving assistance apparatus comprising:
an advancement direction travel control unit that performs travel control in an advancement direction by applying at least one of a driving force and a braking force to a vehicle;
an execution determination unit that determines whether or not the travel control in the advancement direction is being executed by the advancement direction travel control unit; and
a driving assistance unit that performs driving assistance on the basis of a travel condition in the advancement direction of the vehicle,
wherein the driving assistance unit suppresses the driving assistance when the execution determination unit determines that the travel control in the advancement direction is being executed by the advancement direction travel control unit.

2. The driving assistance apparatus according to claim 1, wherein:
the driving assistance unit comprises a diminished awareness determination unit that determines whether or not a driver of the vehicle is in a state of diminished awareness; and
the driving assistance unit suppresses a determination by the execution determination unit that the driver of the vehicle is in the state of diminished awareness when the diminished awareness determination unit determines that the travel control in the advancement direction is being executed by the advancement direction travel control unit.

3. The driving assistance apparatus according to claim 2, wherein:
the driving assistance unit further comprises a warning unit that issues a warning when the diminished awareness determination unit determines that the driver of the vehicle is in the state of diminished awareness; and
the driving assistance unit suppresses an issue of the warning by the warning unit when the execution determination unit determines that the travel control in the advancement direction is being executed by the advancement direction travel control unit.

4. The driving assistance apparatus according to claim 3, further comprising a vehicle width direction travel control unit that performs travel control in a vehicle width direction by applying a steering force to the vehicle,
wherein the execution determination unit determines whether or not the travel control in the vehicle width direction is being executed by the vehicle width direction travel control unit,
the diminished awareness determination unit determines whether or not the driver of the vehicle is in the state of diminished awareness on the basis of a travel condition in the vehicle width direction of the vehicle, and
the driving assistance unit suppresses the driving assistance when the vehicle width direction travel control unit is determined to be executing the travel control in the vehicle width direction.

5. The driving assistance apparatus according to claim 4, wherein, when the execution determination unit determines that the travel control in the advancement direction is being executed by the advancement direction travel control unit, the diminished awareness determination unit determines diminished awareness on the basis of the travel condition in the vehicle width direction of the vehicle, and
when the execution determination unit determines that the travel control in the vehicle width direction is being executed by the vehicle width direction travel control unit, the diminished awareness determination unit determines diminished awareness on the basis of the travel condition in the advancement direction of the vehicle.

6. The driving assistance apparatus according to claim 1, wherein the driving assistance unit issues a warning to a driver of the vehicle when a reduction rate in a vehicle speed is determined to be at or above a predetermined vehicle speed reduction rate, when a reduction rate in an accelerator pedal depression amount is determined to be at or above a predetermined accelerator depression amount reduction rate, or when a variation rate in a inter-vehicle distance between the vehicle and a preceding vehicle is determined to be at or above the predetermined variation rate.

7. A driving assistance method comprising:
performing travel control in an advancement direction by applying at least one of a driving force and a braking force to a vehicle;
determining whether or not the travel control in the advancement direction is being executed;
performing driving assistance on the basis of a travel condition in the advancement direction of the vehicle; and
suppressing the driving assistance when the travel control in the advancement direction is determined to be underway.
